(19) United States
(12) Patent Application Publication
(10) Pub. No.: US 2019/0031404 A1
(43) Pub. Date: Jan. 31, 2019

(54) ATTACHMENT FOR A WASHING OR RINSING AGENT BOTTLE

(71) Applicant: Henkel AG & Co. KGaA, Duesseldorf (DE)

(72) Inventors: Ingomar Henning, Koeln (DE); Stefan Strathmann, Erkrath (DE); Bernhard Orlich, Duesseldorf (DE)

(73) Assignee: Henkel AG & Co. KGaA, Duesseldorf (DE)

(21) Appl. No.: 16/148,377

(22) Filed: Oct. 1, 2018

Related U.S. Application Data
(63) Continuation of application No. PCT/EP2017/055606, filed on Mar. 9, 2017.

(30) Foreign Application Priority Data
Apr. 1, 2016 (DE) 102016205451.1

(51) Int. Cl. B65D 47/08; B65D 53/02; B29C 45/16; B29C 45/76

(52) U.S. Cl. CPC B65D 47/0804; B65D 53/02; B29C 45/1676; B29L 2031/565; B29C 2945/76153; B29C 2945/7629; B29K 2995/0018; B29C 45/768

(57) ABSTRACT

An attachment for a washing or rinsing agent bottle. The attachment is made from a main component and at least one auxiliary component in a multicomponent injection casting method, wherein a seal element is molded using the auxiliary component. The main component or the auxiliary component has a marker which causes a contrast between the auxiliary component and the main component under UV light or IR light. The invention also relates to a method for producing such an attachment.

### FIELD OF THE INVENTION

The invention relates to an attachment for a washing or rinsing agent bottle, and to a method for producing such an attachment.

### BACKGROUND OF THE INVENTION

WO 2015/090690 A1 discloses an attachment in the form of a closure, which can be screwed onto a bottle neck of a washing or rinsing agent bottle. The closure comprises a movable hinged lid and a seal element. The seal element ensures that washing or rinsing agent cannot leak out of the bottle through the closure when the hinged lid is in a closed position.

The requirements placed on the seal element or on a leakproof closure are comparatively high for a washing or rinsing agent bottle. Bottles of this kind are increasingly being distributed via electronic commerce (e-commerce), and therefore, for example while being shipped by a parcel service, the bottles may be kept in any position for a long period of time, even with the bottle neck and closure inclined downwards. In the latter case, the washing or rinsing agent would come into direct contact with the seal element. A closure that is not leakproof would therefore invariably lead to the contents of the bottle leaking out. Even the smallest error or irregularity in the seal leads to undesired leakage, in particular if the bottle contains a washing or rinsing agent which contains ingredients for reducing surface tension.

Washing or rinsing agent bottles and the attachment are often plastics parts, for example made of polyethylene (PE) or polypropylene (PP), a combination of plastics having different hardnesses preferably being selected for the seal elements in order to create a good sealing effect, for example a soft bottle material (HDPE) and a PP closure that is hard relative to the bottle material, or a hard bottle material (PET) and a PP closure that is soft relative to the bottle material. Separately produced sealing rings are also known, for example, which are used in the closure or between the closure and the bottle in order to generate a difference in hardness for material combinations that have similar hardnesses. However, assembling the sealing ring separately in this way is complex and leads to high production costs.

Producing the attachment from one main component and at least one auxiliary component in a multi-component injection molding process is also known, the seal element being formed by one of the two components. In the multi-component injection molding process, a first element of the attachment is firstly produced from one of the two components by means of injection molding, onto which first element a second element or the remainder is then injection molded from the other component. In this case, the multi-component injection molding process can be used cost-effectively for appropriate quantities.

If, in the multi-component injection molding process, the first injected element is used as a boundary that forms the shape for injection molding the second element, i.e. if it can be considered a part of the injection mold for the second element, an error when injection molding the first element can lead to the second element also being faulty. For example, this error can cause the first element to not be injection molded at all and can remain undetected. This can consequently lead to the total attachment only being formed from one of the two components, since this component also fills the space that has been left empty for the other component. This may result in the closure no longer meeting the requirements placed thereon, in particular the requirements with regard to leakproofness.

It is not readily possible to simply and reliably detect the error described above, in particular for larger quantities. In particular if the first component and the second component are translucent or the same color, an intact closure and a non-intact closure can only be visually distinguished with considerable effort or not at all, since they only differ slightly, if at all, on a superficial level. The effort required to test the function of the individual closure, i.e. to test whether or not said closure is sufficiently tightly closed, would not be proportionate to the other production costs either.

### BRIEF SUMMARY OF THE INVENTION

The problem addressed by the invention is therefore that of providing an attachment for a washing or rinsing agent bottle which is produced in a multi-component injection molding process, has a sufficiently good sealing effect and can be produced reliably and cost-effectively.

According to the invention, the main component or the auxiliary component has a marker which causes a contrast between the main component and the auxiliary component under UV light or IR light. In other words, the marker means that the two components can be distinguished from one another under UV light or IR light. Whereas the components do not differ from one another under visible light, because they are both translucent or the same color, the marker causes a reproducible contrast under non-visible light.

The main component and auxiliary component preferably differ in the shot weights thereof. The main component can in this case have a greater shot weight than the auxiliary component. The shot weight of the main component and auxiliary component can also be the same. The auxiliary component may also be referred to as the first component and the main component may also be referred to as the second component.

UV light is understood to be electromagnetic waves that have a wavelength of between 1 nm and approximately 390 nm. In order of increasing wavelength, the visible light spectrum, which has wavelengths of from approximately 390 to 780 nm, comes immediately after UV light. IR light (infrared radiation) refers to electromagnetic waves that have a wavelength of greater than 780 nm. An upper limit for wavelengths of IR light may be 50 μm or even 1 mm.

The marker may be a UV marker which emits a visible light when exposed to UV light. The UV marker is therefore a substance which absorbs energy from the non-visible UV light (for example from 290 to 390 nm) and, after intermolecular interaction, emits some of the absorbed energy at a wavelength that falls within the range of visible light (for example from 400 nm to 700 nm). The marker is preferably a fluorescent substance which stops emitting visible light at practically the same time as the irradiation with UV light stops.

However, the marker does not necessarily have to be a substance which is excited by electromagnetic waves and emits visible light as a result. It can also be a substance which absorbs radiation of particular wavelengths which fall within the range of UV light or in the range of IR light, without emitting visible light in the process. This absorption, which does not have to be perceptible to the naked eye, can however be detected within the scope of infrared spectroscopy, for example.

The marker in the form of a UV marker can be an optical brightener, which transforms the portions of UV that are found in daylight but are not visible into visible light. When exposed to UV light from an artificial light source, for example in the form of a mercury vapor lamp or from UV light diodes, the brightener clearly stands out against the components that do not have a brightener.

Suitable groupings for the molecules of optical brighteners are heterocyclic five-membered rings or compounds in which a condensed aromatic is directly connected to a heteroaromatic, such as thiazoles, pyrazoles, oxadiazoles or triazines (for example 2,4-dimethoxy-6-(1′-pyrenyl)-1,3,5-triazine). Optical brighteners may also be, in particular: stilbene compounds such as blankophors; ethylene, phenylethylene and thiophene derivatives which contain two heteroaromatic functional groups (e.g. the benzoxazole functional group); coumarin and carbostyril derivatives; naphthalimides (N-methyl-4-methoxy-naphthalimide).

It is preferable for the auxiliary component that forms the seal element to have the marker. As a result, the auxiliary component clearly stands out against the main component when exposed to UV light or IR light, and therefore the presence of the auxiliary component can be confirmed.

The auxiliary component may be softer than the main component. The main component may also be softer than the auxiliary component. In one embodiment of the invention, the main component and auxiliary component are equally hard.

The auxiliary component preferably has a Shore A hardness of from 30 to 90 ShA at 23° C. In one embodiment, the Shore A hardness is from 60 to 80 ShA. The specified hardnesses each relate to the components in the injection-molded state.

The main component may be made of plastics material, preferably from polypropylene (PP) or polypropylene (PE). The auxiliary component may be a thermoplastic elastomer (TPE).

A washing or rinsing agent bottle is understood to be a bottle which is suitable for receiving liquid washing or rinsing agent and comprises a bottle neck that has an opening for filling and emptying the bottle. In this case, the bottle neck is suitable for being connected to the attachment. For example, the attachment may be a closure for closing the bottle or a pourer which makes it easier for the liquid washing or rinsing agent to be discharged. The bottle neck is preferably hollow cylindrical at least in the upper region. The amount with which the bottle can be filled may be from 100 ml to 3000 ml.

The closure may comprise a base part for fastening the closure on the washing or rinsing agent bottle and a hinged lid for opening and closing the closure. The closure is preferably designed as a plastics part made of PP or PE. The hinged lid, which is preferably movably fastened on the base part, can be integrally connected to said base part by means of a film hinge.

The hinged lid may comprise a closure plug which is used as a seal element and sits in a pouring spout of the base part when the hinged lid is in a closed position. Closure plugs and pouring spouts are in this case designed such that washing or rinsing agent cannot leak out of the bottle when the hinged lid is in a closed position.

In the embodiment above, the seal element abuts a sealing surface which is part of the pouring spout or part of the base part and therefore part of the closure. Alternatively, the attachment and the seal element can also be designed such that the seal element abuts a sealing surface of the washing or rinsing agent bottle when the attachment is in a usage position. For example, it is possible for the seal element to be a sealing ring, which abuts an annular end surface of the cylindrical bottle neck of the washing or rinsing agent bottle. It is also conceivable for the seal element to abut a lateral surface of the cylindrical bottle neck when the attachment is in the usage position.

In one embodiment, the auxiliary component forms a further element which is integral with the seal element and has an outer surface that is accessible or clearly visible from outside. For example, the closure plug described above may also be integrally connected to a lid top of the hinged lid, the lid top forming the outer surface that is accessible or visible from outside.

The closure is preferably designed such that a distinction can be made by means of the marker when the hinged lid is in a closed position. The element that is integrally connected to the seal element and also made from the first component can be larger than the actual seal element with regard to volume, weight and/or dimensions. For example, the injection-molded volume of the element that is integrally connected to the seal element can be two or even three times larger than the seal element, it being intended for the seal element to only comprise what is necessary for the sealing function.

A further problem addressed by the invention, namely that of providing a method for producing an attachment for a washing or rinsing agent bottle, the attachment preferably having one of the above-described designs, is solved by the combination of features disclosed herein.

In the method according to the invention, the attachment that has the seal element is injection molded in a multi-component injection molding process. The attachment has the auxiliary component for forming the seal element, and the main component, with one of the components comprising the marker. After the injection molding process, the attachment is exposed to UV light or IR light, and under the UV light or IR light an imaging unit creates an image of the attachment. The image is evaluated in order to determine the presence of a contrast between the auxiliary component and the main component caused by the marker.

A separate light source, for example UV light diodes, is preferably used to provide the UV light or IR light, that is to provide the electromagnetic radiation at appropriate wavelengths. However, resorting to daylight or even the light from fluorescent tubes, for example, and using the portions of the electromagnetic spectrum which do not belong to visible light (from 390 nm to 780 nm) for the method according to the invention is also conceivable.

An attachment can be considered defective when said attachment does not have a contrast under UV light or IR light. For example, a particular threshold value may be defined for the contrast. The relevant attachment is considered good and not defective only when this threshold value is exceeded. A comparison with a reference image of an exemplary attachment can also be made under UV light or IR light, any variations then having to be less than a particular threshold value in order for the relevant attachment not to be rejected.

In the multi-component injection molding process, the auxiliary component that forms the seal element is preferably injection molded first and the main component second.

In the method according to the invention, a substance that causes absorption in the IR spectrum at a predetermined wavenumber at which there is no absorption in the IR spectrum of the main component can be used as a marker in the auxiliary component. Therefore, the marker does not necessarily have to be a substance which is only added to the auxiliary component for the purpose of creating a contrast. It may also be a substance which is already present in one of the two components, and which displays a characteristic absorption in the IR spectrum (or in the UV spectrum) that the other component does not have. For example, the auxiliary component may be a TPE which, at a wavenumber of approximately 700/cm (or specifically from 685 to 695/cm) and/or at a wavenumber of approximately 540 (specifically from 535 to 545/cm), has a corresponding absorption in the IR spectrum.

### BRIEF DESCRIPTION OF THE DRAWINGS

The invention is described in more detail with reference to the embodiments shown in the drawings, in which:

FIG. 1 shows an attachment in the form of a closure that comprises a base part and a hinged lid;

FIG. 2 shows the closure in FIG. 1 having the hinged lid in an open position;

FIG. 3. is a view from above of four closures in FIG. 1;

FIG. 4 is a longitudinal section through a further attachment in the form of a pourer;

FIG. 5 shows the detail V in FIG. 4 on a larger scale; and

FIG. 6 is a longitudinal section through a further attachment in the form of a cap.

### DETAILED DESCRIPTION OF THE INVENTION

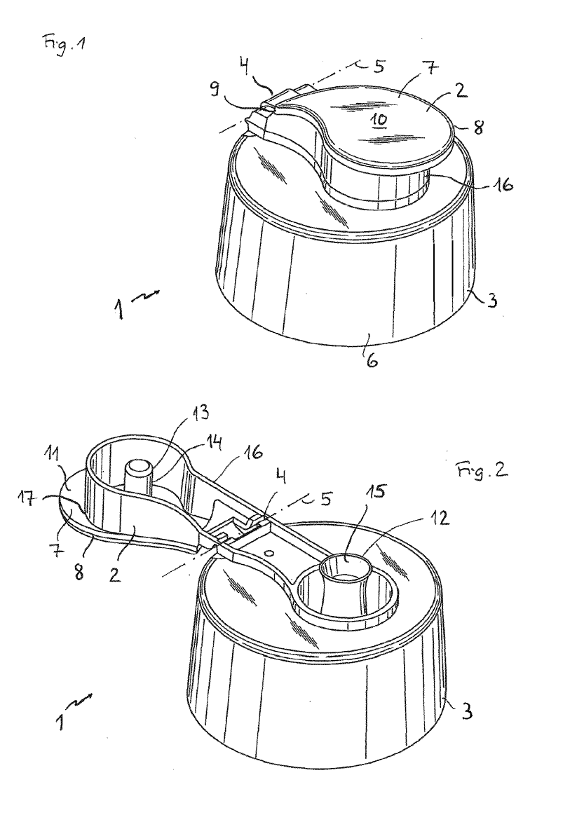

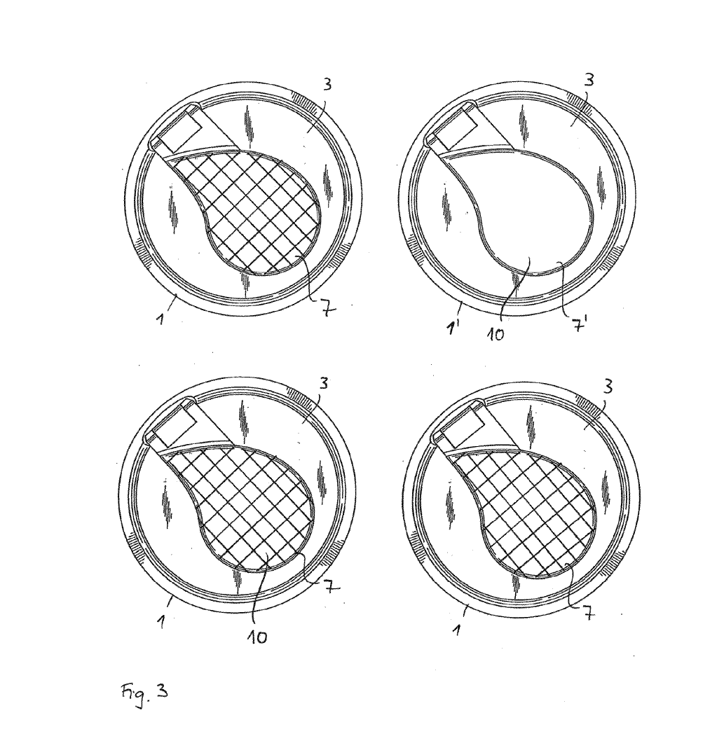

FIG. 1 is a perspective view of an attachment in the form of a closure that is denoted in its entirety by reference sign 1. The attachment or closure 1 comprises a hinged lid 2 and a base part 3. While FIG. 1 shows the hinged lid 2 in a closed position, FIG. 2 shows the hinged lid 2 in an open position. The hinged lid 2 is hingedly or pivotally connected to the base part 3 by means of a film hinge 4. A pivot axis about which the hinged lid 2 can be pivoted is denoted by reference sign 5.

The base part has a cylindrical basic shape having a lateral surface 6, on the inner face (not visible in FIGS. 1 and 2) of which fastening means are provided for fastening the closure 1 to a bottle neck of a bottle (not shown here) for washing or rinsing agent. For example, the fastening means may comprise an internal thread which interacts with an external thread on the bottle neck of the bottle. The fastening means may also be part of a snap connection between the closure 1 and the bottle neck. The diameter of the lateral surface 6 of the base part may be from 1 to 6 cm or from 1.5 to 3 cm, for example.

The hinged lid 2 comprises a lid top 7 that is delimited by a peripheral rim 8. When viewed from above, the lid top 7 is approximately in the shape of an asymmetric drop. In a front part of the hinged lid 2, the lid top 7 is approximately semi-circular; the corresponding rim 8 delineates a semi-circle in said front region. In a rear part of the hinged lid 2, the lid top 7 tapers acutely towards the pivot axis 5. Correspondingly, the lid top 7 comprises a tip 9 near to the pivot axis 5. The lid top 7, which is flat in the embodiment in FIGS. 1 and 2 but which may also be curved or bent, has an outer surface 10 and an inner surface 11, the inner surface 11 facing towards the base part 3 when the hinged lid 2 is in a closed position (see FIG. 1). In the view in FIG. 1, the outer surface 10 faces upwards, while the inner surface 11 faces downwards towards the base part 3.

A pouring spout 12 is provided which is slightly offset from a middle axis of the cylindrical lateral surface 6 of the base part 3 and through which the liquid content can flow out of the washing or rinsing agent bottle onto which the closure 1 can be attached when the hinged lid 2 is in the open position. When the hinged lid 2 is in a closed position, a closure plug 13 sits in the pouring spout 12. The closure plug 13 has the basic shape of a hollow cylinder or hollow cone having a lateral surface 14. When the hinged lid 2 is in a closed position, the lateral surface 14 abuts an inner surface 15 of the pouring spout 12, and therefore liquid content cannot leak out of the bottle through the pouring spout 12. The closure plug 13 is therefore a seal element, by means of which the pouring spout 12 can be sealed or closed.

The closure 1 is produced from two different components. A first component or auxiliary component, for example a thermoplastic polyolefin (PP), in this case forms the closure plug 13 and the lid top 7. The closure plug 13 and the lid top 7 are therefore integrally interconnected and made from the same material.

The remainder of the closure 1, specifically the base part 3 comprising the pouring spout 12 and a side wall 16 of the hinged lid 2, which connects the lid top 6 and the closure plug 13 to the base part 3 by means of the film hinge 4, is made of a second component or a main component. This main component is preferably polypropylene or polyethylene.

The closure 1 is produced in a multi-component injection molding process, the lid top 7 first being injection molded together with the closure plug 13 in an injection mold. This first produces said asymmetrical drop, from the inner surface 11 of which the hollow cylindrical closure plug 13 extends substantially perpendicularly (taking into account draft angles, the closure plug 13 is more specifically a hollow cone). The main component is then injected onto the lid top 7, in order to form the base part 3 and the side wall 16 comprising the film hinge 4.

The first molded element, which consists of the closure plug 13 and the lid top 7, forms some of the boundary surfaces that form the shape for the element of the closure 1 which is injection molded from the main component in the second step. In other words, the auxiliary component that has already been injection molded represents a part of the cavity for the main component. The cavity for the second component may in this case consist of mold parts or mold halves of the cavity for the auxiliary component. The injection molded auxiliary component may for example remain in a main part of the cavity thereof, if the main component is injection molded thereon.

The side wall 16 is molded onto the inner surface 11 of the hinged lid 2. An upper rim 17 of the side wall 16 lies in the plane of the inner surface 11. If an error occurs and remains undetected while the first component is being injection molded, the possibility cannot be ruled out that, when injecting the second component, not only the base part 3 and the side wall 16, but also the lid top 7 and the closure plug 13 will be formed from the main component. If the auxiliary component and main component do not differ in terms of their visual properties (transparency, color, etc., in each case under irradiation with visible light), it is difficult to assess whether the lid top 7 and the closure plug 13 consist of the auxiliary component as intended, while the remainder of the closure 1 consists of the main component. Faulty injection molding that has not been detected can lead to the meticulously designed seal between the closure plug 13 and the pouring spout 15, which includes the particular material pairing, not working. There is therefore a risk that the closure 1, which only consists of the main component, is not sufficiently leakproof.

For this reason, the auxiliary component which forms the lid top 7 and the closure plug 13 has a marker, as a result of which the auxiliary component can be distinguished from the main component under UV light. The marker absorbs the UV light and emits radiation at a wavelength of visible light, and therefore a difference in color between the components is perceptible to the naked eye.

FIG. 3 is a view from above of four closures, three of which are denoted by reference sign 1 and the closure in the top right is denoted by reference sign 1′. The three closures 1 each have the lid top 7 which differs from the lid top 7′ of closure 1′. This difference becomes apparent under UV light as a result of the marker provided in the auxiliary component. The hatching on the outer surface 10 of the lid top 7 is intended to denote particular coloring which can be seen in the visible light range, as a result of the marker, when irradiated with UV light. In the closure 1′ in FIG. 3, this particular coloring cannot be seen. The closure 1′ clearly does not have the auxiliary component, but instead has been injection molded completely from the main component.

Using an imaging unit, for example a digital camera, images of the four closures can be taken under UV light and evaluated. The evaluation then tests whether there is a corresponding contrast between the lid top 7 and the remainder of the closure 1 or whether the current image matches a reference image. This can also detect if the sealing component is partially lacking or has moved, for example. If a contrast of this kind or a match with the image is detected when irradiated with UV light, the relevant closure passes the test and is put to further use, for example the closure 1 is screwed onto the washing or rinsing agent bottle after it has been filled. The closure 1′ which does not show a contrast (see FIG. 3, top right) is defectively produced and is discarded. Automated testing may therefore be carried out after the multi-component injection molding process within the production process in order to be able to separate out defective closures.

Simultaneously imaging four closures is understood to be an example. More than four closures may clearly also be checked simultaneously. It is also possible for the injection molded closures to each be individually supplied to the camera one after the other and, correspondingly, for the evaluation to be carried out successively.

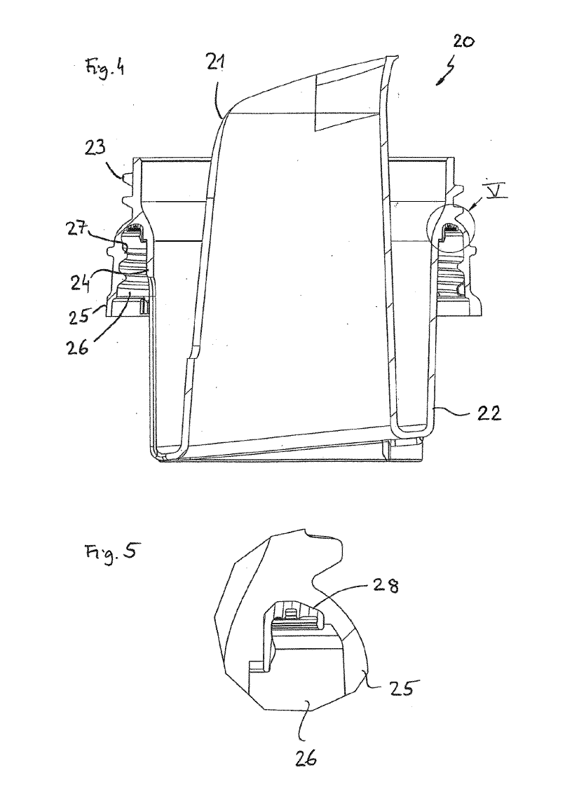

FIG. 4 shows a further attachment in the form of a pourer 20. The attachment or pourer 20 comprises a pouring spout 21 and a cylindrical base body 22. An external thread 23 is provided in an upper region on the base body 22, onto which external thread a closure cap (not shown) can be screwed. An inner wall 24 and an outer wall 25, the outer diameters of which are, for example, from 30 to 60 mm, define a receiving chamber 26 for receiving a bottle neck of a washing or rinsing agent bottle onto which the pourer can be attached. An external thread on the bottle neck can be screwed into an internal thread 27 in the receiving chamber.

A seal element 28 is provided on the upper end of the receiving chamber 26; see in particular FIG. 5, which is an enlarged view of the detail V in FIG. 4. In this case the attachment 20 is also intended to have been produced in a multi-component injection molding process, the auxiliary component forming the seal element 28 and the main component forming the remainder of the attachment/pourer 20. The seal element is preferably made of TPE, whereas the pourer is made of PP or PE.

The auxiliary component comprises a UV marker, which emits visible light when irradiated with UV light and therefore creates a visible contrast to the second component which does not comprise this UV marker. In order to test whether the seal element 28 has also been formed by the auxiliary component as intended, and not by the main component due to a fault, the pourer 20 in the view of FIG. 4 can be irradiated from below with UV light. The contrast caused by the UV marker can be detected using images from a camera, which is likewise directed towards the interior space 26 from below, and used as a basis for deciding whether the attachment is defective or not. In particular, error patterns can be detected and classified when comparing the current image and reference images, and this is a good tool for rectifying faults and thus improving the production process. Uncritical errors can also be “isolated”, if these do not impair the function.

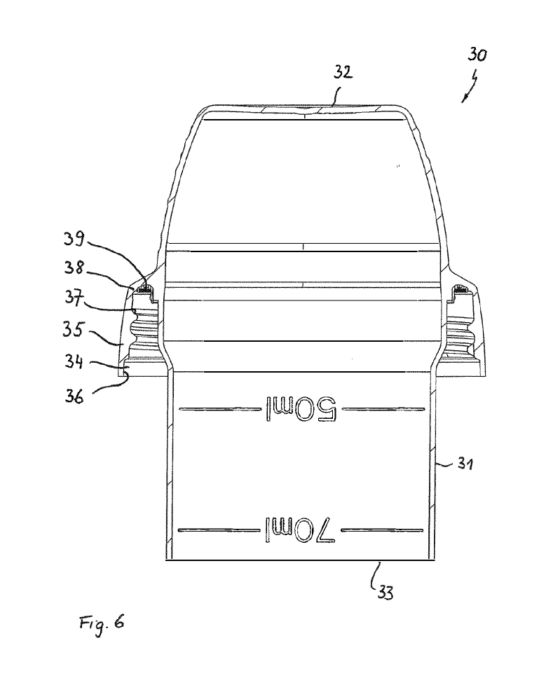

FIG. 6 shows a further embodiment of the attachment in the form of a cap or closure cap 30. The cap is cup-shaped and has a substantially cylindrical side wall 31, one end of which abuts a base 32. An open end 33 of the cap 30 is located opposite the base 32.

A receiving chamber 34 for receiving an upper end of a bottle neck of a bottle (not shown) is provided approximately in the middle between the base 32 and the open end 33. The receiving chamber 34 is delimited by an outer wall 35 and the cylindrical side wall 31, the cylindrical side wall 31 representing a radially inner boundary. An internal thread 37 is provided on the inner face or on the face 36 of the outer wall 35 that faces the receiving chamber, which internal thread can interact with an external thread on the bottle neck of the bottle. A seal element 39 is arranged at an upper end 38 of the receiving chamber 34, which seal element corresponds to the seal element 28 in the embodiment in FIGS. 4 and 5.

### LIST OF REFERENCE SIGNS

1 Attachment/closure
2 Hinged lid
3 Base part
4 Film hinge
5 Pivot axis
6 Lateral surface
7 Lid top
8 Rim
9 Tip
10 Outer surface
11 Inner surface
12 Pouring spout
13 Closure plug/seal element
14 Lateral surface
15 Inner surface
16 Side wall
17 Upper rim
20 Attachment/pourer
21 Pouring spout
22 Base body
23 External thread
24 Inner wall
25 Outer wall
26 Receiving chamber
27 Internal thread
28 Seal element
30 Attachment/cap
31 Side wall
32 Base
33 Open end
34 Receiving chamber
35 Outer wall
36 Inner face
37 Internal thread
38 Upper end
39 Seal element

What is claimed is:

1. An attachment for a washing or rinsing agent bottle, the attachment being produced from a main component and at least one auxiliary component in a multi-component injection molding process, a seal element being formed by the auxiliary component, characterized in that the main component or the auxiliary component has a marker which causes a contrast between the main component and the auxiliary component under UV light or IR light.

2. The attachment according to claim 1, characterized in that the auxiliary component that forms the seal element has the marker.

3. The attachment-according to claim 1, characterized in that the auxiliary component is softer than the main component.

4. The attachment according to claim 1, characterized in that the auxiliary component is harder than the main component.

5. The attachment according to claim 1, characterized in that the auxiliary component has a Shore A hardness of from 30 to 90 ShA at 23° C.

6. The attachment according to claim 1, characterized in that the attachment is a closure, which comprises a base part for fastening the closure on the washing or rinsing agent bottle and a hinged lid for opening and closing the closure.

7. The attachment according to claim 6, characterized in that the hinged lid comprises a closure plug which is used as a seal element and sits in a pouring spout of the base part when the hinged lid is in a closed position.

8. The attachment according to claim 1, characterized in that the seal element abuts a sealing surface of the washing or rinsing agent bottle when the attachment is in a usage position.

9. The attachment according to claim 1, characterized in that a further element is formed by the auxiliary component, which further element is integrally formed with the seal element and has an outer surface that is accessible from outside.

10. A method for producing an attachment for a washing or rinsing agent bottle, wherein the attachment has a seal element, is injection molded in a multi-component injection molding process, and has a main component and an auxiliary component so as to form the seal element, one of which components comprises a marker, wherein after the injection molding process the attachment is exposed to UV light or IR light, an imaging unit creates an image of the attachment under the UV light or IR light, and wherein the image is evaluated in order to determine the presence of a contrast between the auxiliary component and the main component caused by the marker.

11. The method according to claim 10, characterized in that the attachment is considered defective if the contrast does not reach a particular threshold value under UV light or IR light.

12. The method according to claim 10, characterized in that the attachment is considered defective if a particular threshold is exceeded when compared with a reference image under UV light or IR light.

13. The method according to claim 10, characterized in that, in the injection molding process, the auxiliary component is injection molded first and the main component second.

14. The method according to claim 10, characterized in that a substance which causes absorption in the IR spectrum at a predetermined wavenumber at which there is no absorption in the IR spectrum of the main component is used as a marker in the auxiliary component.
